(19) United States
(12) Patent Application Publication
(10) Pub. No.: US 2005/0049959 A1
(43) Pub. Date: Mar. 3, 2005

(54) System and method for controlling bids between suppliers and purchasers

(76) Inventors: Jens-Uwe Gross, Walldorf (DE); Kazuya Imabayashi, Tokyo (JP)

Correspondence Address: Finnegan, Henderson, Farabown,;Garrett & Dunner, L.L.P., 1300 I Street, N.W., Washington, DC, 20005-3315, US

(21) Appl. No.: 10/892,383

(22) Filed: Jul. 16, 2004

(30) Foreign Application Priority Data
Jul. 18, 2003 (JP) 2003-277150

(51) Int. Cl. G06F 17/60

(52) U.S. Cl. 705/37

(57) ABSTRACT

This bid controlling system includes an item display control table having display codes assigned to respective items. The display codes are associated with an estimation classification and a bid participant classification, showing an estimation format of a bid target and showing a display state of a plurality of items that are needed for bidding. By using this table, a display screen for bid participants is generated which performs display processing of a plurality of items corresponding to conditions.

### TECHNICAL FIELD

The present invention generally relates to managing the computerized flow of requests and bids between purchasers and suppliers. Specifically, the present invention relates to a system and method for controlling bids in the case where there are different estimation formats with respect to the same bid target.

### RELATED APPLICATIONS

Priority is claimed to Japanese Patent Application No. 2003-277150 filed on Jul. 18, 2003, the content of which is incorporated herein by reference.

### BACKGROUND

In order to purchase goods or receive supply of a service, a bidding system is often used. In the bidding system, a purchaser, who is a bid client, uses the system to make a request for bidding to suppliers, who are tenderers. Then, from the result of the bidding that is accumulated in the bidding system, the purchaser selects the supplier (refer for example to Japanese Unexamined Patent Application, First Publication No. 2002-352117).

In bidding that includes an estimation, a plurality of bid forms may exist even if the bidding is for the same goods, material or service. Therefore, terms needed for the bidding may be different in some cases. For example, as the bidding format, there is a case where a supplier is newly selected, or there is bidding for requesting revision of the supply price. Furthermore, for example, in the case where the type of business that purchases a plurality of different parts or materials in order to manufacture a finished product becomes the purchaser (who is the bid client), there are a plurality of usage formats for goods, material or service (which becomes the bid target). Therefore, the bid terms may be different in some cases. For example, as the usage format, there is a case where the bid target product is an experimental product, a case where the bid target product is a mass-produced goods, or the like. In this way, if the bidding format or the usage format of the bid target is different, information items needed for the bidding are also different.

Several deficiencies exist in conventional bidding systems. For example, in the bidding system shown in Japanese Patent Publication 2002-352117, in the case where information items needed for the bidding are different, the bidding format or the usage format of the bid target is different. That system, however, cannot effectively deal with the situation where information items corresponding to the bidding format or usage format that are input or displayed to the purchaser or supplier are different.

### SUMMARY

In accordance with one aspect of the present invention, a bid controlling system that generates a display screen for bid participants includes an item display control table wherein display codes are assigned to respective items. The display codes are associated with an estimation classification and a bid participant classification, showing an estimation format of a bid target and showing a display state of a plurality of items that are needed for bidding. The system further includes a search key obtaining section that obtains information related to the estimation classification of the bidding from bid data in order to make a search key and specifies a bid participant classification in order to make another search key, where the bid data includes information related to bidding. The system also includes an item display control table search section that searches the item display control table based on the search key and specifies respective display codes of the plurality of items corresponded to the search key. Finally, a display processing section conducts display processing of the plurality of items based on the respective display codes searched and generates a display screen for bid participants.

By providing the aforementioned display item control table, even in the case where there are a plurality of estimation formats of the bid target, display processing for only the items that become necessary corresponding to the estimation format, becomes possible. Further, display control of the items that become necessary corresponding to the estimation format also becomes easy. Furthermore, even in the same estimation format, the display processing of only the items that become necessary corresponding to the bid participants such as the purchaser or supplier, becomes possible, and the display control of the respective articles becomes easy. The bid participants include the person who requests the bidding and the person who approves the bidding.

Moreover, the bid controlling system is characterized in that the search key obtaining section specifies the bid participant classification by a program being executed. Therefore, even if the types of programs being executed are increased this can be dealt with. Moreover, the input participants can be classified corresponding to the programs being executed. Regarding the bid participant classification, it is also possible to classify the user bid participant by the user information that controls the system, for example the user ID and the database controlling the user, instead of the program being executed.

Moreover, the bid controlling system is characterized in that the display codes of a plurality of items in the item display control table are further associated with a category showing a usage format of a bid target. Further, the search key obtaining section may obtain information related to a category of the bidding by the bid data, to make another search key. Also, the item display control table search section may use a search key related to the category to specify the respective display codes of the plurality of items.

By the aforementioned display item control table, in the case where there are a plurality of usage formats of the bid target, display processing of only the items that become necessary corresponding to the usage format becomes possible, and the display control of the items that become necessary corresponding to the usage format becomes easy.

Moreover, the bid controlling system is characterized in that the display codes of a plurality of items in the item display control table are further associated with a screen number specifying the displayed screen contents. As well, the search key obtaining section may further specify the screen number by a program being executed, to make another search key, and the item display control table search section may use a search key related to a screen number to specify the respective display codes of the plurality of items.

By the aforementioned display item control table, even in the case where the estimation classification and the bid participant classification of the bid target are the same and there are a plurality of types of display screen, the display processing of only the items that become necessary corresponding to the display screen becomes possible, and the display control of the items which become necessary corresponding to the display screen becomes easy.

Moreover, the bid controlling system is characterized in that the search key obtaining section further specifies a display mode of a display screen. In a case where a display code set for an item of a processing target is a code showing a different display state depending on the display mode, the display processing section conducts the display processing in a state that the item can only be referenced in a first display mode and conducts the display processing in a state that the item can be updated in a second display mode.

In the aforementioned display item control table, depending on whether the display mode of the display screen is the reference mode where only the displayed items can be referenced, or the update mode which allows input and update of the predetermined items, a display code that makes the display processing of the item different is also set. Therefore, for only the predetermined items among the displayed items, different display processing can be conducted corresponding to the display mode, even though the display code is the same. Moreover, by introducing such a display code, the contents of the display item control table can be kept from increasing.

Furthermore, the bid controlling system is characterized in that the search key obtaining section may use the status showing the progress of the bidding in order to specify the display mode. In the bidding, it is not allowed in some cases to input and update items corresponding to the progress of the bidding. Accordingly, the screen can be controlled corresponding to the status of the bidding, and erroneous input and update of items by the bid participants can be prevented.

In another aspect of the present invention, a method for generating a display screen for bid participants by a computer includes storing an item display control table wherein display codes are assigned to respective items. The display codes are associated with an estimation classification and a bid participant classification, showing an estimation format of a bid target and showing a display state of a plurality of items that are needed for bidding. The method further includes obtaining information related to the estimation classification of the bidding from bid data including information related to bidding in order to make a search key, and specifying a bid participant classification in order to make another search key. The method also includes searching the item display control table based on the search key and specifying respective display codes of the plurality of items corresponding to the search key, processing the plurality of items based on the respective display codes searched, and generating a display screen for bid participants.

In a further aspect of the present invention, a computer-readable medium stores a set of instructions for displaying a screen for bid participants. When executed on a computer, the instructions perform stages including storing an item display control table wherein display codes are assigned to respective items. The display codes are associated with an estimation classification and a bid participant classification, showing an estimation format of a bid target and showing a display state of a plurality of items that are needed for bidding. The performed stages include obtaining information related to the estimation classification of the bidding from bid data in order to make a search key and specifying a bid participant classification in order to make another search key, the bid data including information related to bidding. The performed stages also include searching the item display control table based on the search key, specifying respective display codes of the plurality of items corresponding to the search key, processing the plurality of items based on the respective display codes searched, and generating a display screen for bid participants.

As described above, since the display processing of the items needed for the bidding can be conducted using the item display control table, the effect can be obtained that, even in the case where there are a plurality of estimation formats of the bid target, the display processing of only the items that become necessary corresponding to the estimation format becomes possible. Moreover, the display control of the items that become necessary corresponding to the estimation format becomes easy. Furthermore, the effect can be obtained that, even if they are the same estimation format or the like, the display processing of only the items that become necessary corresponding to the bid participants becomes possible, and the display control of the respective items corresponding to the bid participants becomes easy.

The foregoing background and summary are not intended to be comprehensive, but instead serve to help artisans of ordinary skill understand the following implementations consistent with the invention set forth in the appended claims. In addition, the foregoing background and summary are not intended to provide any independent limitations on the claimed invention.

### BRIEF DESCRIPTION OF THE DRAWINGS

The accompanying drawings show features of implementations consistent with the present invention and, together with the corresponding written description, help explain principles associated with the invention. In the drawings:

FIG. 1 shows a network configuration including a bid controlling system of the present invention.

FIG. 2 is a diagram for explaining a flow of bidding using the bid controlling system.

FIG. 3 shows combinations which require display by estimation classification and category.

FIG. 4 is a diagram for explaining functions related to display processing of items in the bid controlling system of the present invention.

FIG. 5 shows an example of an item display control table.

FIG. 6 shows an example of a parts control table.

FIG. 7 shows a flow of the display processing of respective items in the bid controlling system.

FIG. 8 shows a detailed flow of the display processing of respective items based on the display code.

FIG. 9 shows a display example of a screen in the case where a list of the parts related to the bidding is displayed in a modification mode, with respect to the suppliers.

FIG. 10 shows a display example of a screen in the case where the details of the parts related to the bidding are displayed in the modification mode, with respect to the suppliers.

FIG. 11 shows a display example of a screen in the case where a list of the parts related to the bidding is displayed in a reference mode, with respect to the suppliers.

FIG. 12 shows a display example of a screen in the case where the details of the articles related to the bidding is displayed in the reference mode, with respect to the suppliers.

FIG. 13 shows a display example of a screen in the case where a list of the parts related to the bidding is displayed in the reference mode, with respect to the purchaser.

FIG. 14 shows a display example of a screen in the case where the details of the parts related to the bidding is displayed in the reference mode, with respect to the purchaser.

### DETAILED DESCRIPTION

The following description refers to the accompanying drawings in which, in the absence of a contrary representation, the same numbers in different drawings represent similar elements. The implementations in the following description do not represent all implementations consistent with principles of the claimed invention. Instead, they are merely some examples of systems and methods consistent with those principles. It is to be understood that both the foregoing general description and the following detailed description are exemplary and explanatory only and are not restrictive of the invention, as claimed.

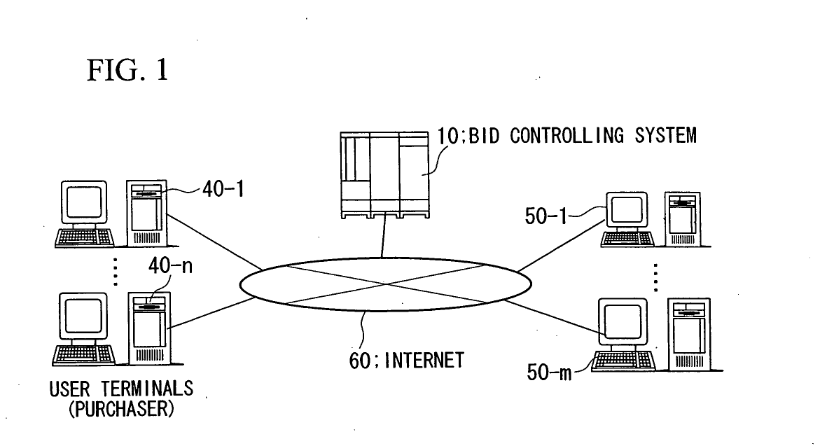

FIG. 1 is a block diagram showing the overall configuration including a bid controlling system 10 of the present embodiment. The bid controlling system 10 of the present embodiment is connected to user terminals 40-1 to 40-n for the purchasers who are estimation request clients, and to user terminals 50-1 to 50-m for the suppliers who are bidders, via a network such as the Internet 60 or the like. The user terminals 40-1 to 40-n and 50-1 to 50-m comprise a reading function for accessing to the bid controlling system in order to receive the information. For example, a reading software (browser) is used as the reading function of the user terminal.

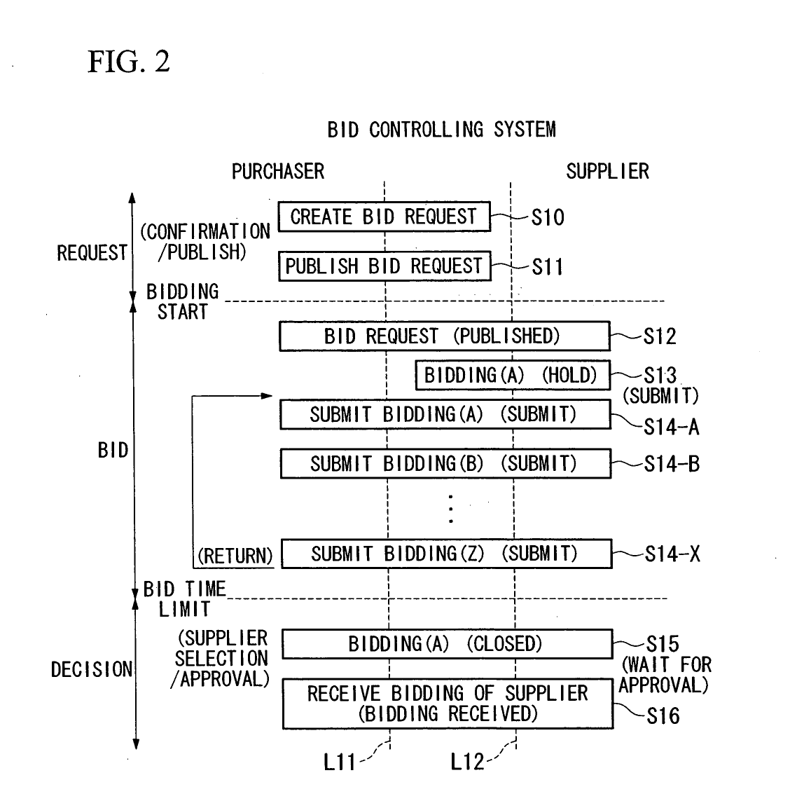

FIG. 2 shows a flow of the bidding using the bid controlling system 10. The bidding can be largely divided into a request phase when a purchaser requests the bidding, a bid phase by suppliers, and a decision phase for selecting the supplier based on the bid result after the bid time limit.

The purchaser logs in to the bid controlling system 10 using the user terminal for the purchaser, then newly creates a bidding and sets the information to the items needed for the bidding, in order to newly request bidding (step S10). The items needed for the bidding include for example, information, necessary amount, bid time limit, and desired delivery, of the goods that become the bid target.

Subsequently, the purchaser confirms and corrects the information set to the items needed for the bidding, as required. Then, in order to publish the bid request for notifying the created bid request to the suppliers who become the bid target, the purchaser modifies the status of this bid request into ‘publish’ (step S11). The data related to this bid request is accumulated and controlled in the bid controlling system 10. The above step S10 and step S11 become a request phase.

By modifying the status of the bid request into ‘publish,’ the condition becomes such that the suppliers who are nominated by the bid request or those who are able to bid, can refer to this bid request (step S12). For example, by the publication of the bid request, the bid controlling system 10 notifies the publication of the new bid request to the suppliers who are nominated by the bid request or who are able to bid, by e-mail. A supplier who receives the notification, logs in to the bid controlling system 10 using the user terminal for supplier, in order to refer to the new bid request.

Next, the supplier creates the bid data being the data related to the bid contents, based on the bid request (step S13). In step S13, an example is shown where a supplier A creates the bid data by setting the bid price or the like. Regarding the bid data A at this point, the condition is such that only the supplier A who created the bid data, can refer and modify. The status at this time is called ‘Hold.’ The data related to this bidding is accumulated and controlled in the bid controlling system 10.

After the items set to the bid data are confirmed and modified as required, the supplier A modifies the status of the bid data A from ‘Hold’ to ‘Submit’ in order to submit the bidding for making a bid (step S14-A). As a result, the condition becomes such that the bid data A related to this submitted bidding can also be referred to by the purchaser who requested the bidding. Other suppliers also make bids by respectively performing steps S13 and S14-A, similarly to the supplier A (step S14-B to S14-Z).

The above steps S12 to S14 become a bid phase. In the bid phase, if it is before the bid time limit, then in the case where the purchaser is not satisfied with the bid result, he/she can return the bidding submitted by the supplier to the supplier. The supplier to whom the bidding is returned, can then modify the contents of the bidding and rebid if before the bid time limit. In this case, the status of the bid data when the bidding submitted by the supplier is returned to the supplier, is called ‘Return.’ On the other hand, the status of the bid data when the supplier modifies the contents of the returned bidding and resubmits, is called ‘Resubmit.’

Next, after the bid time limit, the purchaser selects the supplier based on the bid result and approves the bid result (step S15). The status of the bid data after the bid time limit has past, is assumed to be ‘Closed,’ and the status of the bid data after the supplier is selected based on the bid result and the bid result is approved, is assumed to be ‘Bidding Received.’ Here, the assumption is that the bidding by the supplier A was approved. The status of the bid data related to the bidding which was not approved, becomes ‘Bidding Rejected.’

According to the status of the bid data after the approval, the supplier who bid is notified by e-mail or the like (step S16). The above steps S15 to S16 become a bid phase.

The above is a flow of the bidding using the bid controlling system 10. In FIG. 2, the steps crossing the broken line L11 shown on the purchaser side denote the state where only the purchaser can refer to the data, and the steps crossing the broken line L12 shown on the supplier side denote the state where only the supplier can refer to the data. Moreover steps crossing both broken lines L11 and L12 denote the state where both the purchaser and the supplier can refer to the data.

Incidentally, even if the bidding is for the same goods, material or service, a plurality of estimation classifications being the bid formats of the bid target exist, and therefore conditions of the bidding or information needed for the bidding may be different in some cases. Furthermore, for example, in the case where the type of business that purchases a plurality of different parts or materials, becomes the purchaser, there are a plurality of categories that are the usage formats of goods, material or service which becomes the bid target, and therefore the conditions of the bidding or information items needed for the bidding become different.

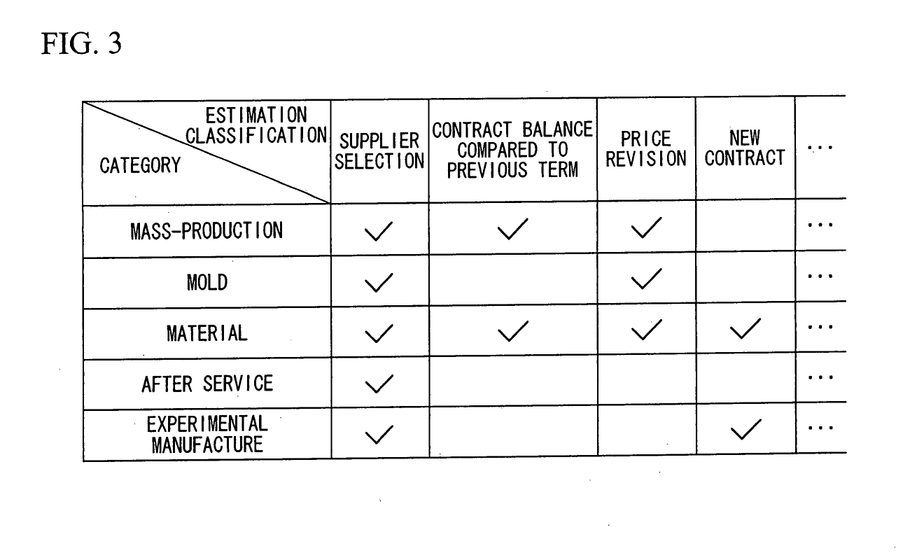

As shown in FIG. 3, examples of the estimation classification includes ‘supplier selection,’ ‘contract balance compared to previous term,’ ‘price revision,’ ‘new contract,’ and the like. Here ‘supplier selection’ denotes the bidding as the estimation request for selecting the supplier of the bid target, and ‘contract balance compared to previous term’ denotes the bidding as the estimation request related to the previous contract balance. Moreover, ‘price revision’ denotes the bidding as the estimation request for revising the price, and ‘new contract’ denotes the bidding as the estimation request for newly contracting the bid target.

Category includes ‘mass-production,’ ‘mold,’ ‘material,’ ‘after service,’ ‘experimental manufacture,’ and the like. Here, ‘mass-production’ denotes the case where the bid target is used as mass-produced goods, ‘mold’ denotes the case where the bid target is used as a mold for manufacturing other products, and ‘material’ denotes the case where the bid target is used as the material for when manufacturing other products. Moreover, ‘after service’ denotes the case where the bid target is used as parts for maintaining or repairing products, and ‘experimental manufacture’ denotes the case where the bid target is used as an experimental product.

Depending on the combinations of the above estimation classification and the category, there are combinations without the symbol ‘✓’ in FIG. 3, which can not be the bid target. Also, depending on the combinations of the above estimation classification and the category, the information items needed for the bidding are different. Furthermore, even if the combinations of the estimation classification and the category are the same, the information which the purchaser needs for the bidding and the information which the tenderer needs for the bidding are different. Assuming that the combinations of the estimation classification and the category is ‘40,’ and the total number of the information items needed for dealing with all bid patterns determined by the combination of the estimation classification and the category is ‘40,’ then since the display items needed by the purchaser and the supplier are different, the necessary pattern number of the display items becomes 3200 (=40×40×2). Consequently, the bid controlling system comprises an item display control table which controls the display of the respective items in order to easily control the patterns of the necessary display items. That is, the table controls whether the items are displayed or not displayed, or whether the items for displaying are displayed in the state enabling input or displayed in the state enabling only referencing.

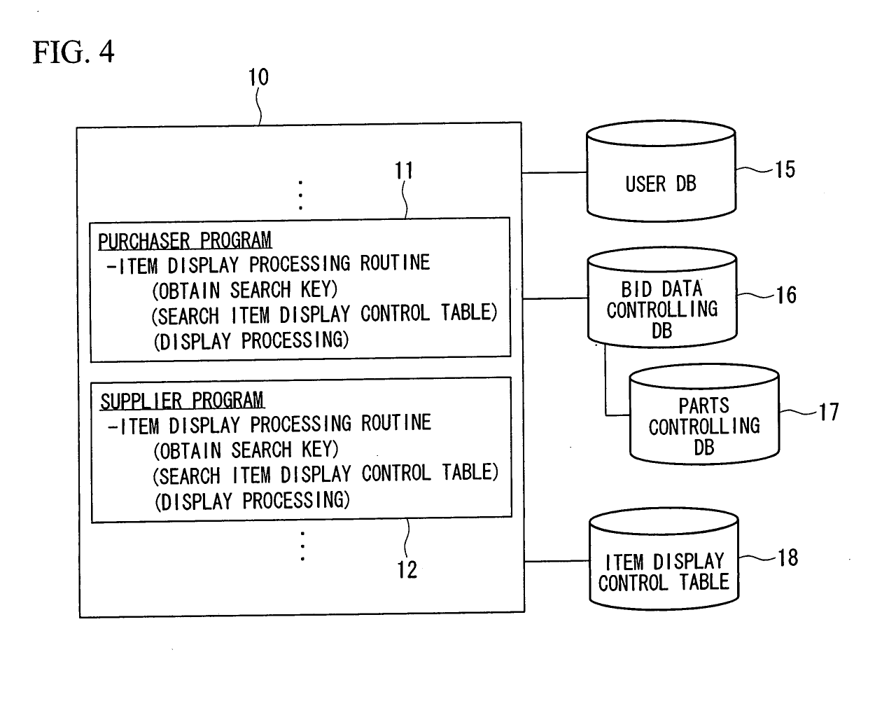

FIG. 4 is a diagram for explaining functions related to the display processing of items in the bid controlling system 10 of the present invention. As shown in FIG. 4, the bid controlling system 10 comprises a user database (user DB) 15 for user control, a bid data controlling database (bid data controlling DB) 16 which accumulates the bid data being the state of the respective bidding or the information related to the bidding, and the item display control table 18 above described. The bid data controlling database 16 is associated with a parts controlling database (parts controlling DB) 17 which controls the information related to one or a plurality of parts being the bid target in the bidding, with respect to the bid data.

Moreover, the bid controlling system 10 stores a plurality of computer programs (modules) and executes the respective computer programs as required in order to control the bidding. The stored computer programs include a purchaser program 11 that is executed when the purchaser logs in to the bid controlling system 10 using the user terminal, and a supplier program 12 that is executed when the supplier logs in to the bid controlling system 10 using the user terminal. The purchaser program 11 and the supplier program 12 include an item display processing routine, which conducts the display processing of the items needed for the bidding corresponding to the bid conditions/terms or the status of the bid data. This item display processing routine includes a search key obtaining function, an item display control table search function, and a display processing function. Here, ‘search key obtaining function’ is a routine which realizes a function for obtaining the search key needed when searching the item display control table 18 and for obtaining the other functions needed for the display processing of the items. ‘Item display control table search function’ is a routine which searches the item display control table 18 using the search key obtained by the search key obtaining function, in order to obtain the display codes of a plurality of items corresponding to the search key. ‘Display code’ is a code showing the display state of the respective articles. ‘Display processing function’ is a routine which conducts the display processing of the plurality of items based on the respective display codes retrieved, in order to generate the display screen for bid participants. Here, ‘bid participants’ include the purchaser and the suppliers. In the present embodiment, the examples are in the case where only the purchaser and the supplier exist as ‘bid participants.’

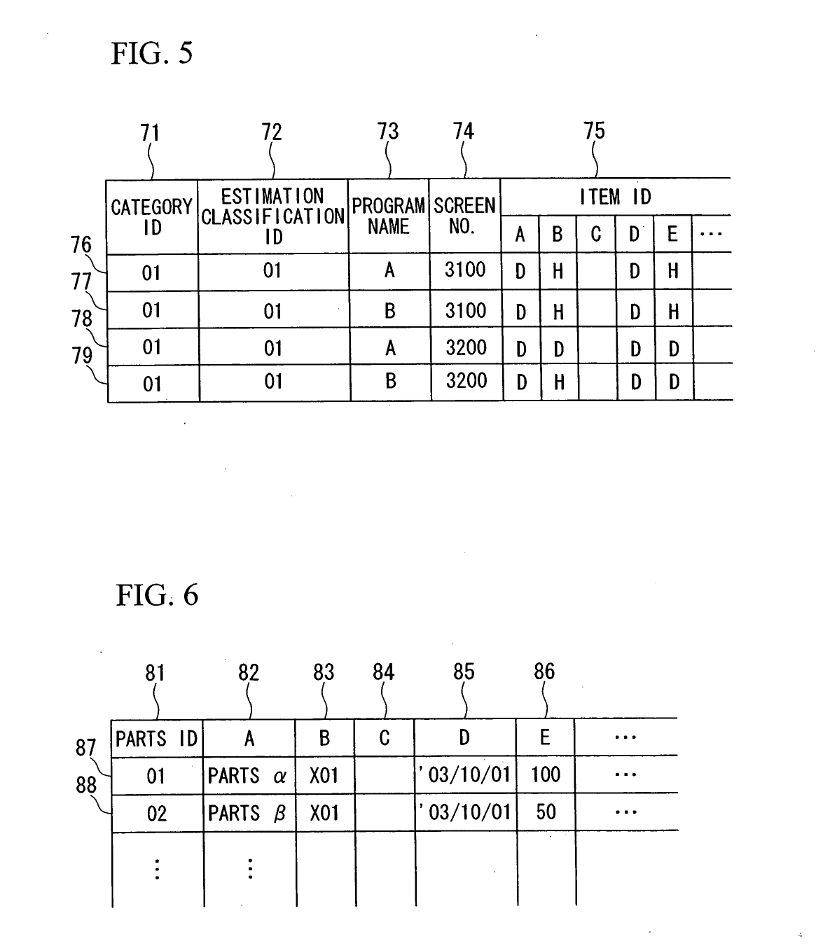

Next is a description of the item display control table 18. FIG. 5 shows an example of a configuration of the item display control table 18. As shown in FIG. 5, the item display control table 18 includes as fields: a category ID 71, an estimation classification ID 72, a program name 73, a screen number (screen No.) 74 and an article ID 75.

Here, ‘category ID’ is an ID for specifying the category showing the usage format of the bid target. Moreover, the detailed information of the category name can be specified by using the category ID and by referring to a category control table which is not shown in FIG. 4. In the example in FIG. 5, it is assumed that the category ID ‘01’ denotes the category ‘mass-production.’

‘Estimation classification ID’ is an ID for specifying the estimation classification showing the estimation format of the bid target. The detailed information such as the estimation classification name can be specified by using the estimation classification ID and by referring to an estimation classification control table which is not shown in FIG. 4. In the example in FIG. 5, it is assumed that the estimation classification ID ‘01’ denotes the estimation classification ‘supplier selection.’

‘Program name’ denotes the program name for referring to the item display control table 18. In the present embodiment, as shown in FIG. 4, there are at least the purchaser program 11 and the supplier program 12 as the program for referring to the item display control table 18, and whether the bid screen for purchaser is generated or the bid screen for supplier is generated can be specified by the program name. In the example in FIG. 5, it is assumed that the program name ‘A’ denotes the purchaser program 11 and the program name ‘B’ denotes the supplier program 12.

‘Screen No.’ is the information for specifying the screen number displayed by the executed program. ‘Screen No.’ is provided so that it becomes possible to control the display processing of the items needed for the bidding corresponding to the type of displayed screen. In the example in FIG. 5, it is assumed that the screen No. ‘3100’ denotes a list display screen that displays the parts group of the bid target in the bidding that becomes the processing target, and the screen No. ‘3200’ denotes a detailed display screen that displays the details of a specified part in the parts group of the bid target in the bidding that becomes the processing target.

‘Item ID’ is an ID for specifying the items needed for the bidding. In the columns of the item ID, all items are enumerated in order to deal with all the combinations of the estimation classification and the category needed to be displayed. The detailed information such as item name of the respective items can be specified by using the item ID and by referring to an item control table, which is not shown in FIG. 4. In the example in FIG. 5, it is assumed that the item ID ‘A’ denotes the part name, the article ID ‘B’ denotes the project name, the article ID ‘C’ denotes the bid price (price), the article ID ‘D’ denotes the delivery data, and the article ID ‘E’ denotes the necessary amount. Moreover, the display codes are respectively set with respect to the respective item IDs. In the example in FIG. 5, ‘D,’ ‘H’ and blank (‘Void’) are set as the display codes. Here, the display code ‘D’ denotes to display in the state where the item can only be referenced, and the display code ‘H’ denotes not to display the items. Moreover, the display code ‘Void’ denotes that the displaying method differs corresponding to the display mode, which is determined based for example on the status of the bid data at the point when the purchaser or the supplier referred to the bid data. The display code ‘Void’ denotes either one of: display in the state enabling only referencing the item, or display in the state enabling modification to the item, corresponding to the display mode.

In FIG. 5, the item display control table 18 stores whether the items are displayed or not displayed, as a record, with respect to the respective combinations of the categories, the estimation classifications, the programs and the screen numbers, needed to be displayed.

Next is a description of an example of the parts controlling data stored in the parts controlling DB 17, using FIG. 6. The parts controlling data is associated with the respective bid data, and is the data for controlling one or a plurality of parts groups that become the bid target, in the associated bid data. The parts controlling data includes the parts ID 81 and the item columns as fields. This parts controlling data is created by the purchaser creating a new bid request.

Here, ‘parts ID’ is an ID for identifying the respective parts of the bid target in the bid data that becomes the target. Moreover, the respective parts IDs 82 to 86 and so on shown in the item columns, are similar to the respective IDs enumerated in the item ID 75 in FIG. 5.

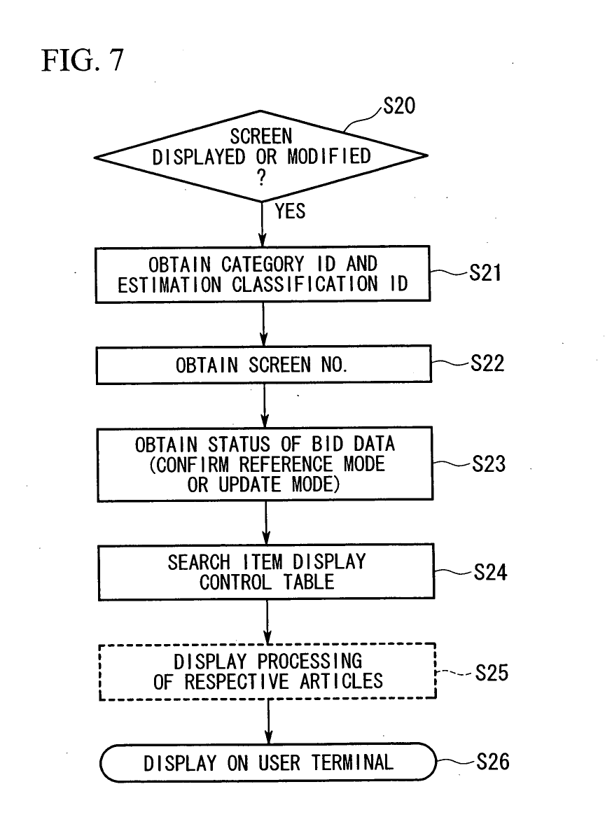

Next is a description of a flow of the display processing of the respective items in the bid controlling system 10, using FIG. 7. Here, it is assumed that either one of the purchaser or the supplier logs in to the bid controlling system 10 and that either one of the purchaser program 11 or the supplier program 12 is started and executed.

If the user screen is displayed or modified by the action of the user on the bid controlling system 10, the item display processing routine is called (step S20).

The search key obtaining function in the item display processing routine obtains the category ID and the estimation classification ID of the bidding by referring to the bid data that becomes the processing target (step S21). In the bid data is included the category ID and the estimation classification ID that are set when the purchaser requests the bidding.

Next, the search key obtaining function obtains the screen number for the display processing (step S22). Since the screen number is the information in the program executed, it is possible to obtain this, for example, by referring to a predetermined memory.

The search key obtaining function obtains the status of the bid data by referring to the status information set in the bid data, and determines whether the display screen to be processed based on this status, is ‘reference mode’ or ‘update mode’ (step S23). For example, in FIG. 2, when the purchaser is accessing the bid data, it is always judged as ‘display mode’ regardless of the status of the bid data. On the other hand, when the supplier is accessing the bid data, the status of the bid data is ‘hold’ or ‘return,’ and when the supplier requests to modify a predetermined item, it is judged as ‘modification mode.’

The search key obtaining function sets its own program name as the search key of the item display control table, together with the category ID, the estimation classification ID, and the screen number that were obtained, in order to hand over to the item display control table search function in the item display processing routine. Moreover, the search key obtaining function sets the mode determined in step S23 as ‘display mode,’ in order to hand over to the display processing function in the item display processing routine.

Next, the item display control table search function in the item display processing routine uses the search key set by the search key obtaining function, and searches the item display control table 18 to determine the record corresponding to the search key and to specify the display code row of the respective articles (step S24). For example, if the search keys are category ID=‘01,’ estimation classification ID=‘01,’ program name=‘A,’ and screen number=‘3100,’ then record 76 is specified in the item display search table 18 shown in FIG. 5, and the display code row of the respective items is specified as ‘D,’ ‘H,’ ‘Void,’ ‘D,’ ‘H’ and so on.

Subsequently, the display processing function in the item display processing routine uses the display code of the respective items specified by the item display control table search function and the display mode set by the search key obtaining function, in order to conduct the display processing of the respective items (step S25). The details of the processing of step S25 are separately described.

When the display processing of the respective items is finished, the created screen is displayed on the user terminal (step S26). The above is the processing flow of the item display processing routine.

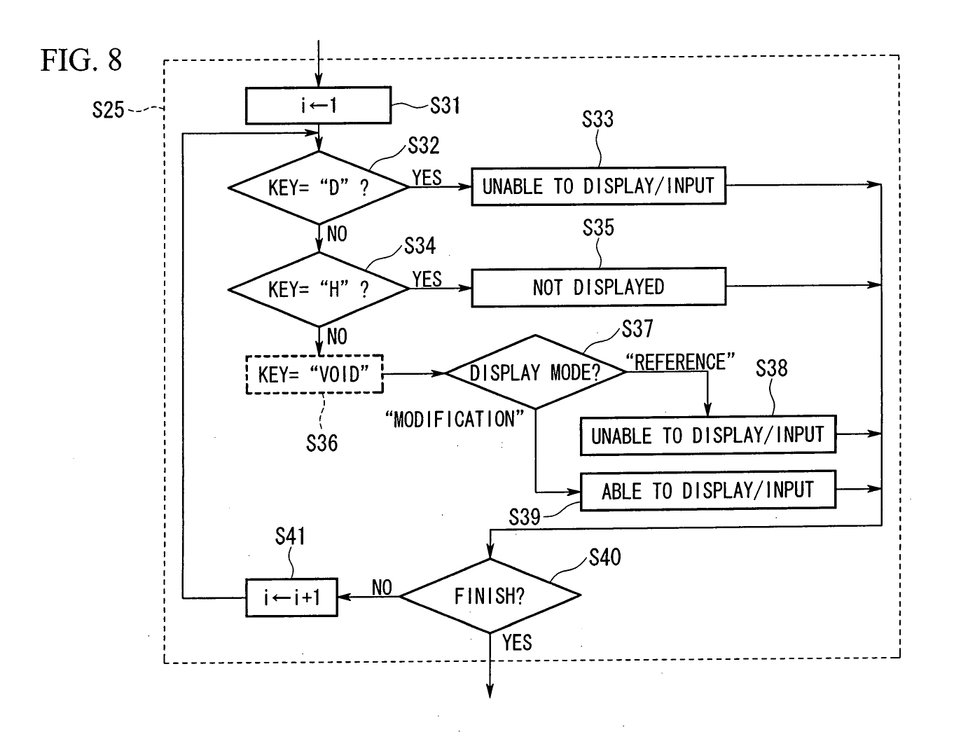

Next is a description of the details of processing flow of the display processing function shown in step 25 in FIG. 7, using FIG. 8. Firstly, a variable ‘i’ for specifying the items that become the processing target is initialized (step S31).

The display key set to the items specified by the variable ‘i’ is judged if it is ‘D’ meaning to display in the state enabling only referencing (step S32). In the case where the display key is ‘D’ (S32: Yes), the item name or the like of the item specified by the variable ‘i’ is specified using the item ID and the item control table, and the item value set by the items specified by the variable ‘i’ is specified by referring to the parts controlling data in the parts controlling DB 17. The specified item name and the item value are display processed, however the item value is display processed in the state enabling only referencing (step S33).

In the case where the display key is not ‘D’ (S32: No), the display key set by the item specified by the variable ‘i’ is judged if it is ‘H’ meaning not to display (step S34). If the display key is ‘H’ (S34: Yes), the items specified by the variable ‘i’ are not display processed (step S35).

In the case where the display key is not ‘D’ (S34: No), the display key set by the items specified by the variable ‘i’ becomes ‘Void’ meaning that the display format changes corresponding to the display mode (step S36). Therefore, it is judged whether the display mode is ‘reference mode’ or ‘modification mode’ (step S37).

In the case where the display mode is ‘reference mode,’ the item name or the like of the items specified by the variable ‘i’ is specified using the item ID and the item control table, and the item value set by the item specified by the variable ‘i’ is specified by referring to the item controlling data. The specified item name and the item value are display processed, however the item value is display processed in the state enabling only referencing (step S38).

In the case where the display mode is ‘modification mode,’ the item name, item value, or the like of the items specified by the variable ‘i’ are specified. In some cases, the item value is not set since the item value is before the setting. The specified item name and the item value are display processed, however the item value is display processed in the state enabling input and modifying (step S39).

When the processing of steps S33, S35, S38 and S39 is finished, it is judged whether the display processing of the respective items enumerated in the item display control table 18 is finished (step S40). In the case where it is judged as ‘finished,’ the processing of the display processing function is finished, and the flow proceeds to step S26 in FIG. 7. On the other hand, if it is not judged as ‘finished,’ the variable ‘i’ is incremented for the display processing with respect to the next item (step S41), and the flow returns to step S32. The above is the processing flow by the display processing function.

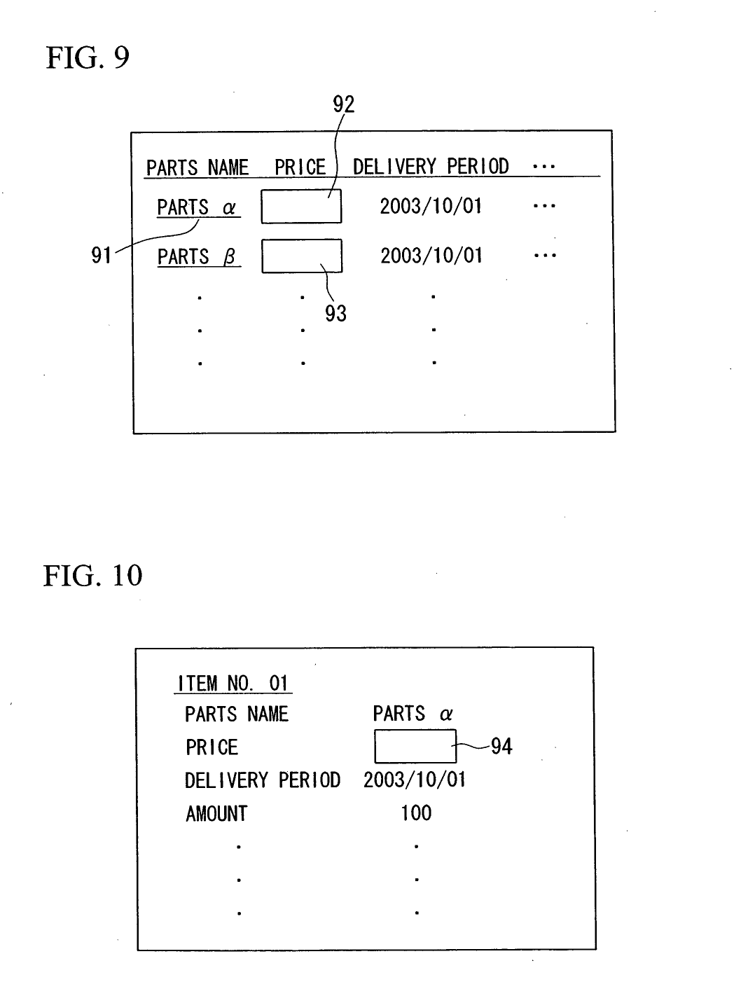

Next is a description of an example of the display screen generated by the bid controlling system 10, and the processing steps for generating the display screen, with reference to FIG. 9 to FIG. 14.

FIG. 9 is an item list display screen in the bidding when the supplier accesses the specified bid data, and a display example of a screen in the case where he/she requests to modify the information item. When this screen is generated, the item display control table 18 shown in FIG. 5 is referenced. It is assumed that the estimation classification of the bid data is ‘supplier selection’ (estimation classification ID=‘01’) and the category is ‘mass-production’ (category ID=‘01’). Moreover, since it is processing due to logging in by the supplier, the supplier program 12 (program name=‘B’) is started. Since the item list display is requested, the screen number becomes ‘3100.’ Moreover, it is assumed that the supplier requests to modify the information item in the state where the status of the bid data is ‘hold’ or ‘return,’ and the display mode is judged as ‘modification mode.’

In this case, the search key obtaining function sets as the search key: category ID=‘01,’ estimation classification ID=‘01,’ program name=‘B’ and screen number=‘3100.’ It also sets ‘update mode’ as the display mode. The item display control table search function refers to the item display control table 18 shown in FIG. 5, based on the search key, and then specifies the display key of the respective items corresponding to the record shown by the symbol 77. The display processing function refers to the display codes set to the respective items of the record of the symbol 77, and serially conducts with respect to the records 87, 88 and so on, showing the respective parts of the parts controlling data shown in FIG. 6. They are: the display processing ‘D’ in the state enabling only referencing, with respect to the item A (parts name), the non display processing ‘H’ with respect to the item B (project name), the display processing ‘Void’ in the state enabling modifying the item value, with respect to the item C (bid price), the display processing ‘D’ in the state enabling referencing, with respect to the item D (delivery period), and the non display processing ‘H’ with respect to the item E (amount). By this processing, the list display screen for the supplier as shown in FIG. 9 is generated. In FIG. 9, an item list screen enabling to set or modify the item value with respect to a predetermined item such as the price or the like, is generated as shown by the symbols 92 and 93.

FIG. 10 is a display screen in the case where the supplier accesses the specified bid data and requests the detailed information of a predetermined part in the bidding, and a display example of a screen in the case where the supplier requests to modify the information item. The screen as in FIG. 10 is generated by the supplier clicking ‘parts α’ denoted by the symbol 91 in the screen shown in FIG. 9, in order to confirm the details of the parts name ‘parts α.’

In this case, since the screen shown in FIG. 10 becomes a transition from the screen shown in FIG. 9, the search key obtaining function sets as the search key: category ID=‘01,’ estimation classification ID=‘01,’ program name=‘B,’ and screen number =‘3200’ showing the detailed screen, and sets ‘update mode’ as the display mode. The item display control table search function searches the item display control table 18 shown in FIG. 5, based on the search key, and then specifies the display key of the respective items corresponding to the record shown in the symbol 79. The display processing function refers to the display codes set to the respective items of the record of the symbol 79, and serially conducts the display processing ‘D’ in the state enabling only referencing, with respect to the item A (parts name), the non display processing ‘H’ with respect to the item B (project name), the display processing ‘Void’ in the state enabling modifying the item value, with respect to the item C (bid price), the display processing ‘D’ in the state enabling referencing, with respect to the item D (delivery period), and the display processing ‘D’ in the state enabling referencing, with respect to the item E (amount), and also refers to the record 87 corresponding to the parts name ‘parts α’ of the parts controlling data shown in FIG. 6, in order to generate the detailed display screen related to the parts α. By the aforementioned processing, the detailed parts screen, that is the display screen for the supplier as shown in FIG. 10, enabling setting or modifying of the item value with respect to the predetermined information item such as the price or the like, as denoted by the symbol 94, is generated.

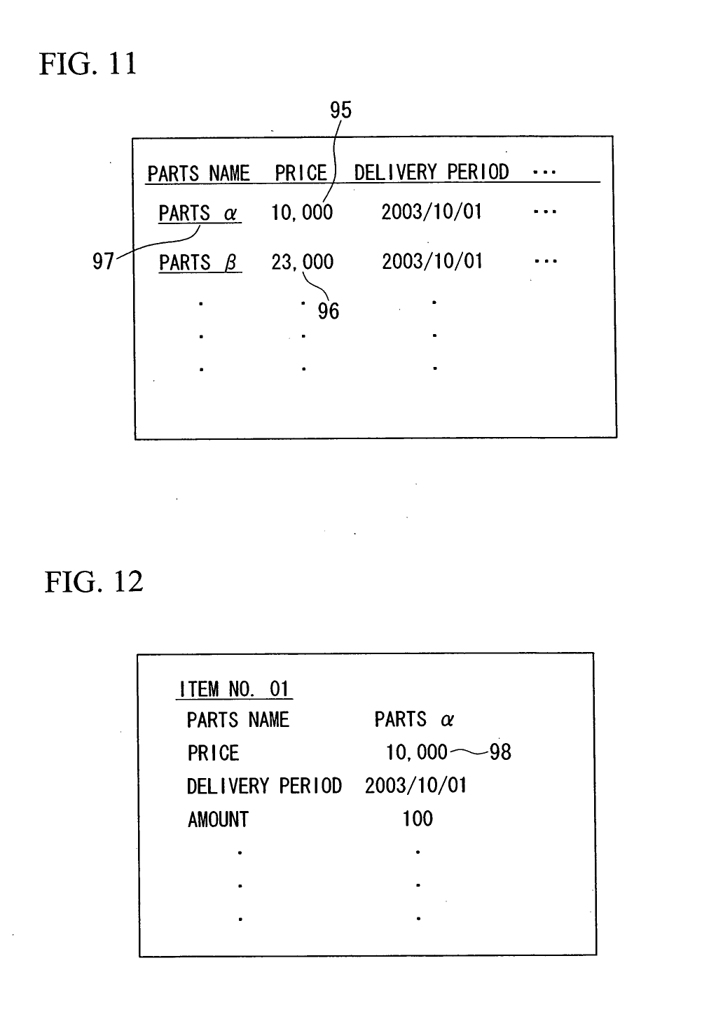

FIG. 11 is a parts list display screen in the bidding, when the supplier accesses specified bid data, being a display example of a screen in the case where the supplier requests to refer to the data related to the bidding. The point of difference from the state where the screen shown in FIG. 9 is generated, is only the point that the display mode is judged as ‘reference mode.’ That is, it is assumed to be the case where the supplier requests to refer to the article value in the state where the status of the bid data is ‘hold’ or ‘return,’ or to be the case where the supplier accesses the bid data in the state where the status of the bid data does not allow modifying the article value.

In this case, the search key obtaining function differs in the point that the ‘reference mode’ is set as the display mode when the screen shown in FIG. 9 is generated. In this case, the item display control table search function also refers to the item display control table 18 shown in FIG. 5 based on the search key, and specifies the display key of the respective items corresponding to the record shown by the symbol 77. Regarding the display processing function, the point of difference from the generating processing of the screen in FIG. 9 is the point that the display code ‘Void’ set with respect to the item C (bid price) is display processed in the state enabling only referencing, with respect to the article value. Therefore, the display screen shown in FIG. 11 differs from the display screen shown in FIG. 9 in the point that the item list screen is generated in the state enabling only referencing the article value, with respect to the predetermined item such as price or the like as shown by the symbols 95 and 96.

FIG. 12 is a detailed display screen of the predetermined items in the bidding when the supplier accesses the specified bid data, being a display example of a screen in the case where the supplier requests to refer to the data related to the bidding. The screen as in FIG. 12 is generated by the supplier clicking ‘parts α’ denoted by the symbol 97 in the screen shown in FIG. 11, in order to confirm the details of the parts name ‘parts α.’

In this case, the screen shown in FIG. 12 becomes a transition from the screen shown in FIG. 11. In this case, the point of difference from generating the display screen shown in FIG. 10, is the point that the display mode is judged as ‘reference mode.’ In this case, the item display control table search function also refers to the item display control table 18 shown in FIG. 5 based on the search key, and specifies the display key of the respective items corresponding to the record shown by the symbol 79. The display processing function differs from the screen generating processing in FIG. 10 in the point that the display code ‘Void’ set with respect to the item C (bid price) is display processed in the state enabling only referencing, with respect to the article value. Therefore, the display screen shown in FIG. 12 differs from the display screen shown in FIG. 10 in the point that the detailed screen of the parts α is generated in the state enabling only referencing the item value, with respect to the predetermined items such as price or the like as shown by the symbol 98.

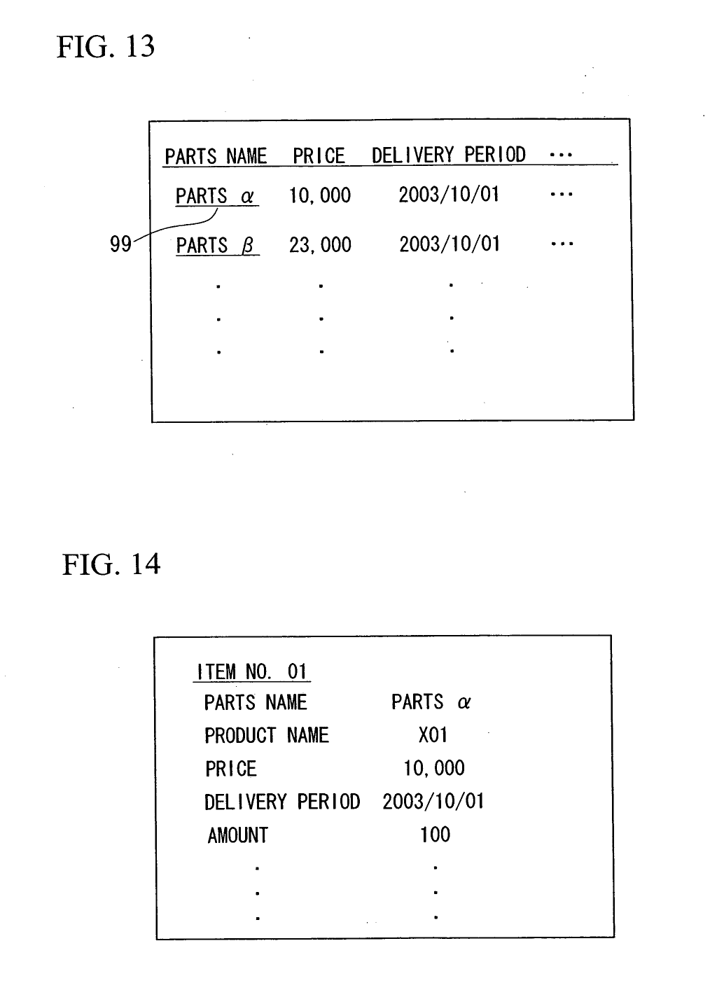

FIG. 13 is a display example of a screen when the purchaser accesses the specified bid data, and in the case where the purchaser requests an item list display screen in the bidding. When this screen is generated, the item display control table 18 shown in FIG. 5 is referenced. It is assumed that the estimation classification of the bid data is ‘supplier selection’ (estimation classification ID=‘01’) and the category is ‘mass-production’ (category ID=‘01’). Moreover, since it is processing due to logging in by the purchaser, the purchaser program 11 (program name=‘A’) is started. Since the item list display is requested, the screen number becomes ‘3100.’ Moreover, when the purchaser accesses the bid data, since it is allowed only to refer to the item value regardless of the status of the bid data, the display mode is judged as ‘reference mode.’

In this case, the search key obtaining function sets as the search key: category ID=‘01,’ estimation classification ID=‘01,’ program name=‘A’ and screen number=‘3100.’ It also sets ‘reference mode’ as the display mode. The item display control table search function refers to the item display control table 18 shown in FIG. 5 based on the search key, and then specifies the display key of the respective items corresponding to the record shown by the symbol 76. The display processing function refers to the display codes set to the respective articles of the record of the symbol 76, and serially conducts, also referring to the records 87, 88, and so on, showing the respective parts of the parts controlling data shown in FIG. 6: the display processing ‘D’ in the state enabling only referencing, with respect to the item A (parts name), the non display processing ‘H’ with respect to the item B (project name), the display processing ‘Void’ in the state enabling only referencing the item value, with respect to the item C (bid price), the display processing ‘D’ in the state enabling referencing, with respect to the item D (delivery period), and the non display processing ‘H’ with respect to the item E (amount). Since the screen number is ‘3100’ denoting the list display of the parts, the display screen showing the list of the respective parts shown in FIG. 6, is generated. By the aforementioned processing, the parts list screen, that is the display screen for the purchaser as shown in FIG. 13, is generated in the state enabling only referencing the respective items displayed.

FIG. 14 is a display screen in the case where the purchaser accesses the specified bid data and requests the detailed information of a specified part in the bidding. The screen as FIG. 14 is generated by the purchaser clicking ‘parts α’ denoted by the symbol 99 in the screen shown in FIG. 13, in order to confirm the details of the parts name ‘parts α.’

In this case, since the screen shown in FIG. 14 becomes a transition from the screen shown in FIG. 13, the search key obtaining function sets as the search key: category ID=‘01,’ estimation classification ID=‘01,’ program name=‘A,’ screen number =‘3200’ showing the detailed screen. It also sets ‘reference mode’ as the display mode. The item display control table search function searches the item display control table 18 shown in FIG. 5, based on the search key, and specifies the display key of the respective items corresponding to the record shown in the symbol 78. The display processing function refers to the display codes set to the respective items of the record of the symbol 78, and conducts the display processing ‘D’ in the state enabling only referencing, with respect to the item A (parts name), the item B (project name), the item D (delivery period), the item E (amount), and so on, and conducts the display processing ‘Void’ in the state enabling only referencing the item value, with respect to the item C (bid price). When this processing is conducted, while also referring to the record 87 corresponding to the parts name ‘parts α’ of the parts controlling data shown in FIG. 6, the detailed display screen related to the parts α is generated. By the aforementioned processing, the detailed screen of the parts for the purchaser, enabling only referencing the item value of the displayed items as shown in FIG. 14, is generated.

The above is the display screen example generated by the bid controlling system 10, and the processing steps when the screen is generated.

Regarding the function of the bid controlling system 10, bid control is conducted by recording a program for realizing this function on a computer readable recording media, and reading in the program recorded on this recording media to a computer system and executing the program. ‘Computer system’ mentioned here is assumed to include the OS or the hardware of the peripherals. Moreover, ‘Computer system’ is assumed to include the WWW system comprising the homepage providing environment (or displaying environment). Furthermore, ‘computer readable recording media’ denotes a portable media such as a flexible disk, a magneto-optical disk, ROM, CD-ROM, or a storage device such as a harddisk built-in to the computer system. Furthermore, ‘computer readable recording media’ is assumed to include a media which holds the program for a fixed time such as with a volatile memory (RAM) inside of the computer system which becomes the sever or the client in the case where the program is sent via a network such as the Internet, or a communication line such as a telephone line.

Moreover, the above program may be transferred from the computer system which has stored this program in a storage device or the like, to another computer system via a transmission media or by transmission waves in the transmission media. Here, the ‘transmission media’ which transmits the program denotes a media having a function for transferring information, as with a network such as the Internet or a communication line such as a telephone line. Moreover, the above program may be for realizing a part of the functions described above. Furthermore, it may be a so-called differential file (differential program), whereby the functions described above can be realized by a combination of the programs that are already recorded in the computer system.

In the above, an embodiment of the present invention has been described in detail, with reference to the drawings. However the specific configuration is not limited to this embodiment, and also includes designs within a scope not deviating from the gist of the invention.

For example, in the present embodiment, the description has focused on parts as an example of the bid target in the bid controlling system 10. However the bid target may be a service, rather than goods.

Moreover, regarding the bidding in the bid controlling system 10, since the agreement is with those who present the most advantageous conditions in trading or contracting, it can also be used for making a plurality of suppliers submit documents on which estimated prices are written, in order to decide on the contractor. However, it can be also used for requesting a predetermined estimation with respect to one specific supplier.

Furthermore, in the present embodiments, there is a ‘program name’ in the field of the item display control table, and the bid participant is specified as any one of the purchaser, part owner, or the like, by this program name. However, the configuration of the item display control table is not limited to this, and it may be such that the bid participant can be specified from other information as a field of this table, or it may be such that the identifier for identifying the bid participant is the field item of the table.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

1. A bid controlling system including a function for generating a display screen for bid participants, said system comprising:
an item display control table having display codes assigned to respective items, the display codes being associated with an estimation classification showing an estimation format of a bid target and a bid participant classification and indicating a display state of a plurality of items that are needed for bidding;
a search key obtaining section obtaining information related to the estimation classification of the bidding from bid data in order to make a search key and specifying a bid participant classification in order to make another search key, the bid data including information related to bidding;
an item display control table search section searching said item display control table based on said search key and specifying respective display codes of said plurality of items corresponding to said search key; and
a display processing section conducting display processing of said plurality of items based on the respective display codes searched and generating a display screen for bid participants.

2. The bid controlling system according to claim 1, wherein said search key obtaining section specifies a bid participant classification by executing instructions stored on a computer-readable medium.

3. The bid controlling system according to claim 1, wherein
the display codes of a plurality of items in said item display control table are further associated with a category showing a usage format of a bid target,
said search key obtaining section further obtains information related to a category of said bidding by said bid data to make another search key, and
said item display control table search section also uses a search key related to the category to specify the respective display codes of said plurality of items.

4. The bid controlling system according claim 1, wherein
the display codes of a plurality of items in said item display control table are further associated with a screen number specifying the displayed screen contents,
said search key obtaining section further specifies the screen number by a program being executed to make another search key, and
said item display control table search section uses a search key related to a screen number to specify the respective display codes of said plurality of items.

5. The bid controlling system according claim 3, wherein
the display codes of a plurality of items in said item display control table are further associated with a screen number specifying the displayed screen contents,
said search key obtaining section further specifies the screen number by a program being executed to make another search key, and
said item display control table search section uses a search key related to a screen number to specify the respective display codes of said plurality of items.

6. The bid controlling system according to claim 1, wherein
said search key obtaining section further specifies a display mode of a display screen, and
said display processing section, in a case where a display code set for an item of a processing target is a code showing a different display state depending on the display mode, conducts the display processing in a state that said item can only be referenced in a first display mode and conducts the display processing in a state that said item can be updated in a second display mode.

7. The bid controlling system according to claim 3, wherein
said search key obtaining section further specifies a display mode of a display screen, and
said display processing section, in a case where a display code set for an item of a processing target is a code showing a different display state depending on the display mode, conducts the display processing in a state that said item can only be referenced in a first display mode and conducts the display processing in a state that said item can be updated in a second display mode.

8. The bid controlling system according to claim 4, wherein
said search key obtaining section further specifies a display mode of a display screen, and
said display processing section, in a case where a display code set for an item of a processing target is a code showing a different display state depending on the display mode, conducts the display processing in a state that said item can only be referenced in a first display mode and conducts the display processing in a state that said item can be updated in a second display mode.

9. A bid controlling system according to claim 6, wherein said search key obtaining section uses a status showing progress of said bidding in order to specify said display mode.

10. A method for generating a display screen for bid participants by a computer, comprising:
storing an item display control table having display codes assigned to respective items, the display codes being associated with an estimation classification showing an estimation format of a bid target and a bid participant classification and indicating a display state of a plurality of items that are needed for bidding;
obtaining information related to the estimation classification of the bidding from bid data in order to make a search key and specifying a bid participant classification in order to make another search key, the bid data including information related to bidding;
searching said item display control table based on said search key and specifying respective display codes of said plurality of items corresponding to said search key; and
processing said plurality of items based on the respective display codes searched and generating a display screen for bid participants.

11. A computer-readable medium on which is stored a set of instructions for displaying a screen for bid participants, which instructions when executed perform stages comprising:
storing an item display control table having display codes assigned to respective items, the display codes being associated with an estimation classification showing an estimation format of a bid target and a bid participant classification and indicating a display state of a plurality of items that are needed for bidding;
obtaining information related to the estimation classification of the bidding from bid data in order to make a search key and specifying a bid participant classification in order to make another search key, the bid data including information related to bidding;
searching said item display control table based on said search key and specifying respective display codes of said plurality of items corresponding to said search key; and
processing said plurality of items based on the respective display codes searched and generating a display screen for bid participants.
